(19) United States
(12) Patent Application Publication
(10) Pub. No.: US 2023/0326068 A1
(43) Pub. Date: Oct. 12, 2023

(54) PTP MANAGEMENT SYSTEM

(71) Applicant: NEC Corporation, Minato-ku, Tokyo (JP)

(72) Inventor: Rui ISHIYAMA, Tokyo (JP)

(73) Assignee: NEC Corporation, Minato-ku, Tokyo (JP)

(21) Appl. No.: 18/019,117

(22) PCT Filed: Aug. 13, 2020
(86) PCT No.: PCT/JP2020/030763

§ 371 Date: Feb. 1, 2023

(51) Int. Cl. G06T 7/73; G06V 10/60; G06V 10/24; G06V 10/56

(52) U.S. Cl. CPC G06T 7/73; G06V 10/245; G06V 10/56; G06V 10/60

(57) ABSTRACT

A system that manages an individual of a PTP sheet includes an acquiring unit configured to acquire an image of a PTP sheet captured from an opening side or a projecting side of a pocket part, an extracting unit configured to extract a feature value depending on a local positional relation between a print part on a cover film in the image and a grid pattern formed on the cover film during thermal bonding, and a generating unit configured to generate individual identification information used for identification of the PTP sheet from the extracted feature value.

### TECHNICAL FIELD

The present invention relates to a PTP management system that manages an individual of a PTP sheet, a PTP management method, and a recording medium.

### BACKGROUND ART

In the field of pharmaceutical packaging, a PTP (Press Through Pack) sheet is widely used as a package for solid formulations such as tablets and capsules. A PTP sheet is formed by housing solid formulations as contents into a plurality of pocket parts having openings on one side of a package film that has the plurality of pocket parts and a flange part provided around the openings to form the one side, and thermally bonding a breakable cover film to the flange part to seal the pocket parts.

Coupled with the ever-worsening problem of counterfeiting medicine, the importance of managing an individual of each medicine is increasing year by year. Therefore, it is an important issue to equip a PTP sheet widely used as a form for packaging medicine with an individual identification function capable of identifying an individual.

In general, a method of setting individual identification information on an object is a method of adhering a label such as a barcode or a QR code (registered trademark) printed with individual identification information or an RFID (Radio Frequency Identifier) with individual identification information stored to an object. A method of printing individual identification information directly on an object using a laser marker, inkjet or the like is also used. However, individual identification by a method of attaching individual identification information to an object requires a label to be adhered to an object, printing equipment for printing on an object, or the like, which increases the cost of manufacturing. Moreover, the method of attaching individual identification information to an object requires adhering a label to an object or printing individual identification information on an object.

On the other hand, identification of an individual of an object is performed using artifact metrics such as bleed in printing or a so-called object fingerprint (see Patent Documents 1 and 2, for example). By such a method, individual identification of an object can be performed without processing for attaching individual identification information.

Patent Document 1: Japanese Patent Publication No. 4337422
Patent Document 2: Japanese Unexamined Patent Application Publication No. JP-A 2019-139640

However, artifact metrics and object fingerprints are very small in size, on the order of micrometers. Therefore, when they are applied to individual identification of a PTP sheet, a high-resolution imaging unit is required.

### SUMMARY

An object of the present invention is to provide a PTP management system that solves the abovementioned issue.

A PTP management system as an aspect of the present invention is a system that manages an individual of a PTP sheet formed by housing contents into a plurality of pocket parts having openings provided on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts. The system includes: an acquiring unit configured to acquire an image of the PTP sheet captured from an opening side or a projecting side of the pocket part on which the print part is formed; an extracting unit configured to extract a feature value depending on a local positional relation between the print part in the image and a grid pattern formed on the cover film during thermal bonding; and a generating unit configured to generate individual identification information used for identification of the PTP sheet from the extracted feature value.

Further, a PTP management method as another aspect of the present invention is a method for managing an individual of a PTP sheet formed by housing contents into a plurality of pocket parts having openings provided on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts. The method includes: acquiring an image of the PTP sheet captured from an opening side or a projecting side of the pocket part on which the print part is formed; extracting a feature value depending on a local positional relation between the print part in the image and a grid pattern formed on the cover film during thermal bonding; and generating individual identification information used for identification of the PTP sheet from the extracted feature value.

Further, a computer-readable recording medium as another aspect of the present invention is a non-transitory computer-readable recording medium on which a computer program including instructions for causing a computer to execute processes is recorded thereon. The computer manages an individual of a PTP sheet formed by housing contents into a plurality of pocket parts having openings provided on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts. The processes includes: acquiring an image of the PTP sheet captured from an opening side or a projecting side of the pocket part on which the print part is formed; extracting a feature value depending on a local positional relation between the print part in the image and a grid pattern formed on the cover film during thermal bonding; and generating individual identification information used for identification of the PTP sheet from the extracted feature value.

With the configurations as described above, the present invention enables individual identification of a PTP sheet without the need for a high-resolution imaging unit.

### BRIEF DESCRIPTION OF DRAWINGS

FIG. 1 is a plan view showing an example of a PTP sheet managed in a first example embodiment of the present invention;

FIG. 2 is a plan view of the PTP sheet shown in FIG. 1, viewed from a back face side thereof (a side of an opening of a pocket part);

FIG. 3 is a cross-section view taken along line X-X in FIG. 1;

FIG. 4A is an enlarged plan view of a main part near a letter “A” of a print part printed on the PTP sheet;

FIG. 4B is an enlarged plan view of a main part near a letter “A” of the same part on a different individual of the PTP sheet from the individual shown in FIG. 4A;

FIG. 5 is a block diagram of a PTP management apparatus according to the first example embodiment of the present invention;

FIG. 6 is a flowchart showing an example of a registration operation of the PTP management apparatus according to the first example embodiment of the present invention;

FIG. 7 is a flowchart showing an example of a matching operation of the PTP management apparatus according to the first example embodiment of the present invention;

FIG. 8 is a flowchart showing an example of processing by a feature value extracting unit of a registering unit in the PTP management apparatus according to the first example embodiment of the present invention;

FIG. 9 is a figure showing an example of a table that defines a plurality of feature points on the print part in the PTP management apparatus according to the first example embodiment of the present invention;

FIG. 10 is a flowchart showing an example of processing at step S12 of FIG. 8;

FIG. 11 is a flowchart showing another example of the processing at step S12 of FIG. 8;

FIG. 12 is a flowchart showing another example of processing by the feature value extracting unit of the registering unit in the PTP management apparatus according to the first example embodiment of the present invention;

FIG. 13 is a figure showing an example of a table that defines a plurality of feature points on a grid pattern in the PTP management apparatus according to the first example embodiment of the present invention;

FIG. 14 is a flowchart showing an example of processing at step S42 of FIG. 12;

FIG. 15 is a flowchart showing another example of the processing at step S42 of FIG. 12;

FIG. 16 is a figure showing a configuration example of an individual identification information DB in the PTP management apparatus according to the first example embodiment of the present invention;

FIG. 17 is a schematic view of a PTP film before punching out the PTP sheet, viewed from a projecting side of the pocket part; and

FIG. 18 is a block diagram of a PTP management system according to a second embodiment of the present invention.

### EXAMPLE EMBODIMENTS

### First Example Embodiment

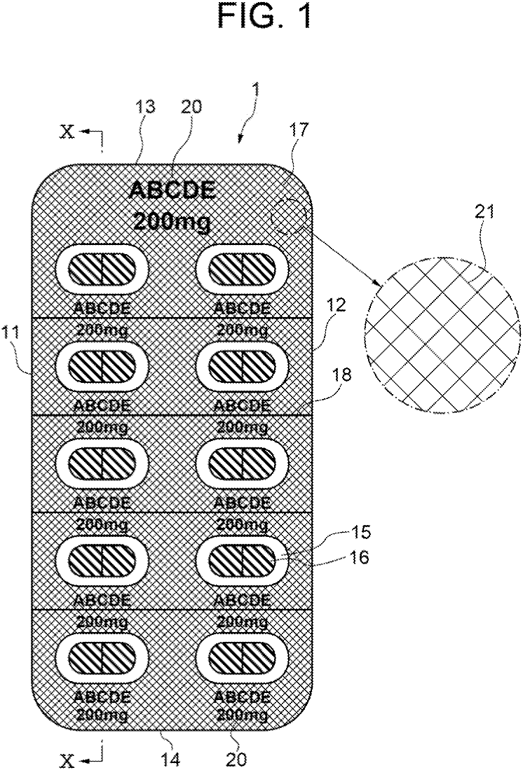

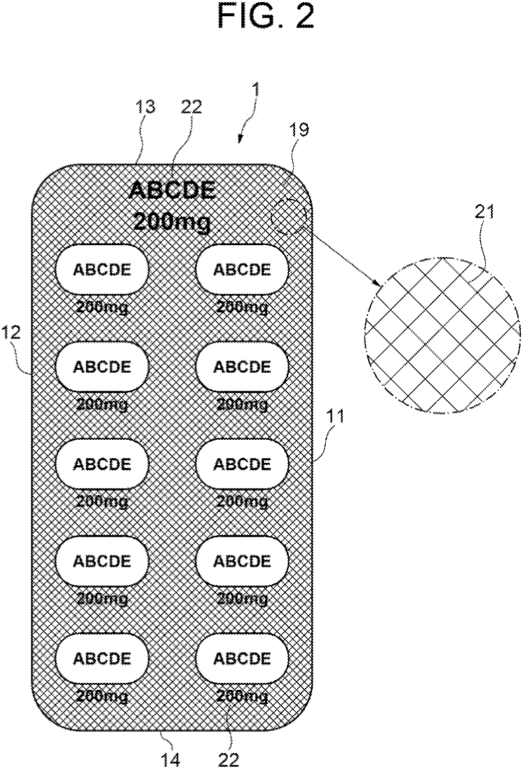

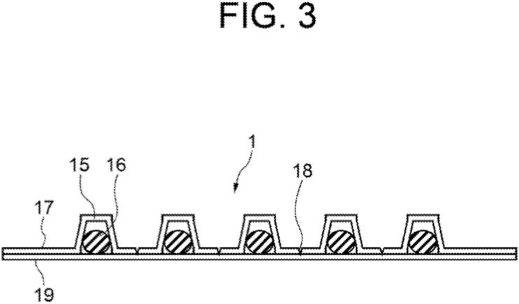

FIG. 1 is a plan view showing an example of a PTP sheet 1 managed in a first example embodiment of the present invention, where the PTP sheet 1 is viewed from a front face side thereof (projecting side of a pocket part 15). Moreover, FIG. 2 is a plan view of the PTP sheet 1 shown in FIG. 1, viewed from a back face side thereof (opening side of the pocket part 15). Furthermore, FIG. 3 is a cross-section view taken along line X-X in FIG. 1. Referring to FIGS. 1 to 3, the PTP sheet 1 has a rectangular shape in a plan view. A peripheral part thereof extends along a longitudinal direction of the PTP sheet 1, and has parallel long side parts 11 and 12 facing each other, and parallel short side parts 13 and 14 provided between the long side parts 11 and 12 and facing each other. On the PTP sheet 1, two pocket rows each including five pocket parts 15 arranged in a direction along the long side parts 11 and 12 are formed in a direction along the short side parts 13 and 14. That is to say, a total of ten pocket parts 15 are formed. In each of the pocket parts 15, one tablet 16 as a content is stored. A package film 17 is made of a transparent or translucent material (for example, unstretched polypropylene, or the like), and has a plurality of horizontal slits 18 formed thereon so as to be cut into pair small pieces each including two pocket parts 15, for example. A cover film 19 is made of an opaque material (for example, aluminum foil, or the like), and has a predetermined print part 20 provided on a side to be attached to the package film 17. In this example, the print part 20 is made by writing a letter string “ABCDE” and a letter string “200 mg” in two rows. One print part 20 is provided corresponding to each of the pocket parts 15, and is also provided on an uppermost part (tag part) of the PTP sheet. The print part 20 is visible from the front face side of the PTP sheet 1 through the package film 17 as shown in FIG. 1. Moreover, since a grid imprint formed at the time of thermally bonding the cover film 19 to the package film 17 is formed not only on the cover film 19 but also on the attachment face of the package film 17, a grid pattern 21 formed by the imprint is visible from the back face side (a side of the cover film 19) of the PTP sheet 1 as shown in FIG. 2, and also visible from the front face side (a side of the package film 17) of the PTP sheet 1 through the package film 17 as shown in FIG. 1.

Further, a predetermined print part 22 is provided on a face of the cover film 19 on the opposite side to the side attached to the package film 17. In this example, the print part 22 is formed by writing a letter string “ABCDE” and a letter string “200 mg” in two rows, which are the same as those of the print part 21. One print part 22 is provided corresponding to each of the pocket parts 15, and is also provided at the uppermost (tag part) of the PTP sheet. Therefore, as shown in FIG. 2, the print part 22 and the grid pattern 21 are visible from the back face side of the PTP sheet 1. As shown in FIG. 2, since an area of the cover film 19 corresponding to the openings of the pocket parts 15 is not pressed at the time of thermal bonding, the grid pattern 21 is not formed thereon.

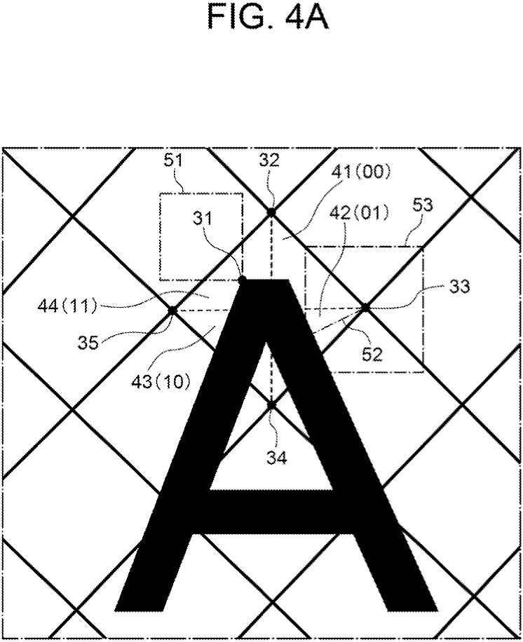

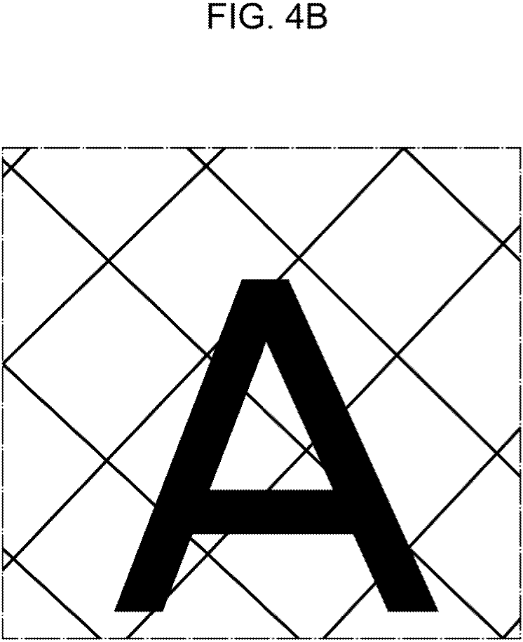

The PTP sheet 1 as described above is manufactured by a PTP packaging machine. For example, the PTP packaging machine manufactures a large number of PTP sheets 1 in a short time through steps including a step of forming the pocket part 15 on a band-shaped transparent or translucent package film 17, a step of filling an article such as the tablet 16 into the pocket part 15, a step of thermally boding a band-shaped cover film 19 to a flange part of the package film 17, and a step of punching a band-shaped PTP film made of the package film 17 and the cover film 19 into PTP sheet units. Aluminum foil or the like is used as the band-shaped cover film 19 in order to facilitate breakage. The print parts 20 and 21 are formed beforehand on both the sides of the band-shaped cover film 19. In the sealing process of thermally bonding the cover film 19 to the package film 17, in order to prevent tear of the cover film 19, occurrence of a pinhole, and the like, at the time of bonding and to achieve strong sealing, the cover film 19 is strongly pressed by a metal hot plate or hot roll processed into a grid pattern with a convex surface. As a result, a grid pattern 21 is formed on the entire flange part of the cover film 19 excluding the pocket parts 15. The grid pattern 21 is visible from the side of the cover film 19, and is also visible from the side of the transparent or translucent package film 17. In the above sealing process, the attachment position of the band-shaped cover film 19 to the band-shaped package film 17 is automatically adjusted so that the print parts 20 and 22 such as letter strings printed on the cover film 19 are positioned appropriately by PTP sheet units. However, since such automatic adjustment is not for controlling the formation position of the grid pattern 21, an influence of slight expansion and contraction of the cover film 19 causes a phenomenon that a positional relation between the print parts 20, 22 and the grid pattern 21 is not the same among all individuals of the PTP sheet 1 and differs among the individuals. An example thereof is shown using FIGS. 4A and 4B.

FIG. 4A is an enlarged plan view of a main part near a letter “A” of the print part 20 printed on a certain individual of the PTP sheet 1. FIG. 4B is an enlarged plan view of a main part near a letter “A” of the same part on a different individual of the PTP sheet 1 from the individual shown in FIG. 4A. Although the letters “A” of the same parts, a positional relation between the letter “A” and the grid pattern 21 therearound is different between the individual shown in FIG. 4A and the individual shown in FIG. 4B.

In this example embodiment, a local positional relation between the print part 20 (or 22) and the grid pattern 21, which may vary with individuals due to the above phenomenon, is utilized to generate individual identification information used for identification of the PTP sheet 1. A PTP management apparatus 100 according to this example embodiment will be described below in detail.

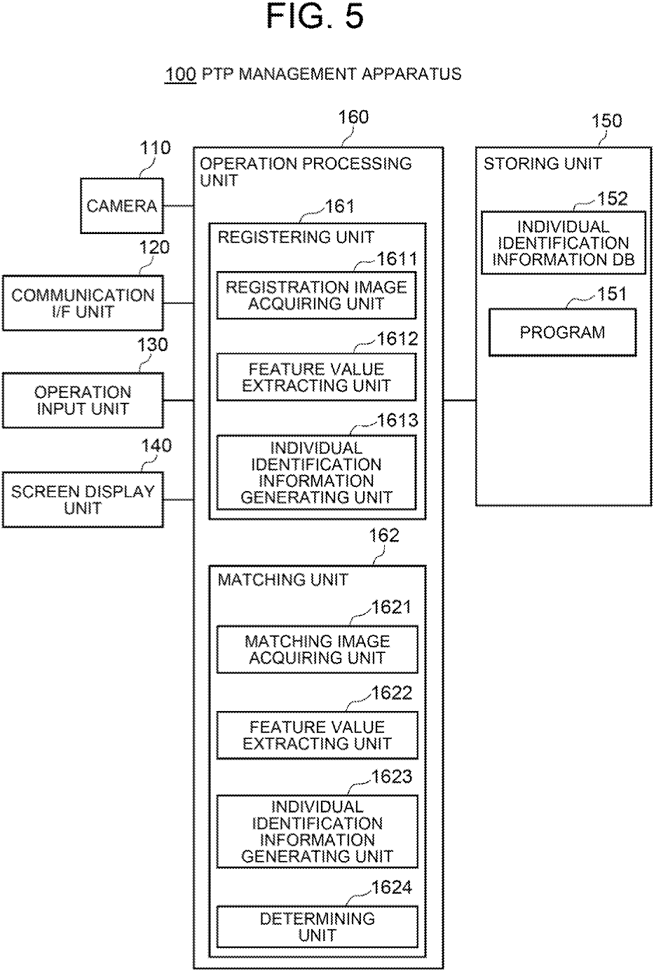

FIG. 5 is a block diagram of the PTP management apparatus 100 according to the first example embodiment of the present invention. The PTP management apparatus 100 shown in FIG. 5 is an information processing apparatus that manages individuals of the PTP sheet 1 for the purpose of manufacturing process management, quality management, shipment management, sales management, and the like.

Referring to FIG. 5, the PTP management apparatus 100 includes a camera 110, a communication I/F unit 120, an operation input unit 130, a screen display unit 140, a storing unit 150, and an operation processing unit 160.

The camera 110 is an imaging device that captures an image of the PTP sheet 1. The camera 110 may be, for example, a visible light color camera or a black and white camera equipped with a CCD (Charge-Coupled Device) image sensor or a CMOS (Complementary MOS) image sensor having a pixel capacity of about millions of pixels.

The communication I/F unit 120 is formed by a data communication circuit, and is configured to perform data communication with an external device wirelessly or by wire. The operation input unit 130 is formed by devices such as a keyboard and a mouse, and is configured to detect an operation by an operator and output to the operation processing unit 160. The screen display unit 140 is formed by a device such as an LCD (Liquid Crystal Display), and is configured to display various information on a screen in accordance with an instruction from the operation processing unit 160.

The storing unit 150 is formed by storage devices such as a hard disk and a memory, and is configured to store processing information necessary for various processing by the operation processing unit 160 and a program 151. The program 151 is a program which is loaded to and executed by the operation processing unit 160 to implement various processing units, and is loaded in advance from an external device or a recording medium, which are not illustrated, via a data input/output function such as the communication I/F unit 120 and stored into the storing unit 150. Major processing information stored in the storing unit 150 is an individual identification information DB 152.

The individual identification information DB 152 is a database in which individual identification information relating to the registration target PTP sheet 1 is stored.

The operation processing unit 160 has a processor such as an MPU and a peripheral circuit thereof, and is configured to load the program 151 from the storing unit 150 and execute the program 151 to thereby make the abovementioned hardware and the program 151 cooperate and implement various processing units. Major processing units implemented by the operation processing unit 160 are a registering unit 161 and a matching unit 162.

The registering unit 161 is configured to generate individual identification information of the registration target PTP sheet 1, and register the individual identification information into the individual identification information DB 152. The registering unit 161 has a registration image acquiring unit 1611, a feature value extracting unit 1612, and an individual identification information generating unit 1613.

The registration image acquiring unit 1611 is configured to acquire an image (a registration image) of the registration target PTP sheet 1 captured from the opening side or projecting side of the pocket part 15 from the camera 110.

The feature value extracting unit 1612 is configured to extract a feature value that depends on a local positional relation between the print part 20 or 22 in the registration image of the PTP sheet 1 acquired by the registration image acquiring unit 1611 and the grid pattern 21 formed on the cover film 19 at the time of thermal bonding.

The individual identification information generating unit 1613 is configured to generate individual identification information used for identification of the PTP sheet 1 from the feature value extracted by the feature value extracting unit 1612, for each registration image of the PTP sheet 1 acquired by the registration image acquiring unit 1611, and store into the individual identification information DB 152.

The matching unit 162 is configured to perform matching of the PTP sheet 1 based on the individual identification information. The matching unit 162 includes a matching image acquiring unit 1621, a feature value extracting unit 1622, an individual identification information generating unit 1623, and a determining unit 1624.

The matching image acquiring unit 1621 is configured to acquire an image obtained by capturing the matching target PTP sheet 1 (a matching image) from the camera 110.

The feature value extracting unit 1622 is configured to extract a feature value that depends on a local positional relation between the print part 20 or 22 in the image of the matching target PTP sheet 1 acquired by the matching image acquiring unit 1621 and the grid pattern 21 formed on the cover film 19 at the time of thermal bonding.

The individual identification information generating unit 1623 is configured to generate individual identification information used for identification of the matching target PTP sheet 1 from the feature value relating to the matching target PTP sheet 1 extracted by the feature value extracting unit 1622.

The determining unit 1624 is configured to compare the individual identification information relating to the matching target PTP sheet 1 generated by the individual identification information generating unit 1623 with the individual identification information relating to the registration target PTP sheet 1 stored in the individual identification information DB 152, and thereby determine whether or not the matching target PTP sheet 1 is identical to any registration target PTP sheet 1. Moreover, the determining unit 1624 is configured to display the result of determination on the screen display unit 140 and/or output the result to an external device through the communication I/F unit 120.

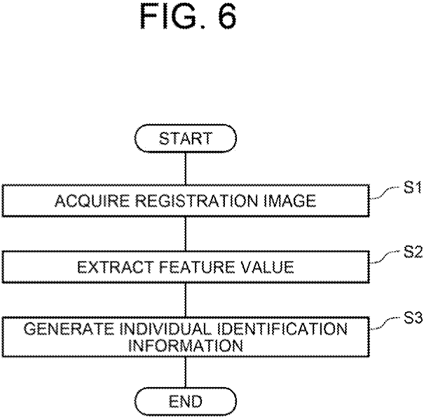

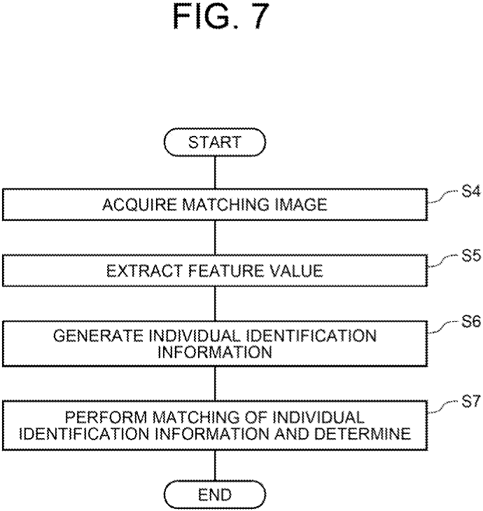

Subsequently, an operation of the PTP management apparatus 100 will be described. The operation of the PTP management apparatus 100 is roughly divided into a registration operation and a matching operation. FIG. 6 is a flowchart showing an example of the registration operation of the PTP management apparatus 100. FIG. 7 is a flowchart showing an example of the matching operation of the PTP management apparatus 100.

First, the registration operation of the PTP management apparatus 100 will be described. In the registration operation, as shown in FIG. 6, the registration image acquiring unit 1611 acquires, for each of individuals of the registration target PTP sheet 1, an image (registration image) obtained by imaging the PTP sheet 1 from the camera 110 (step S1). Next, the feature value extracting unit 1612 extracts, for each of the registration images of the individuals of the PTP sheet 1 acquired by the registration image acquiring unit 1611, a feature value that depends on a local positional relation between the print part 20 or 22 in the image and the grid pattern 21 formed on the cover film 19 at the time of thermal bonding (step S2). Next, the individual identification information generating unit 1613 generates, for each of the registration images of the individuals of the PTP sheet 1 acquired by the registration image acquiring unit 1611, individual identification information used for identification of the individual of the PTP sheet 1 from the feature value extracted by the feature value extracting unit 1612, and stores the individual identification information into the individual identification information DB 152 (step S3).

Next, the matching operation will be described. In the matching operation, as shown in FIG. 7, first, the matching image acquiring unit 1621 acquires an image (matching image) obtained by imaging an individual of the matching target PTP sheet 1 from the camera 110 (step S4). Next, the feature value extracting unit 1622 extracts a feature value that depends on a local positional relation between the print part 20 or 22 in the matching image of the individual of the matching target PTP sheet 1 acquired by the matching image acquiring unit 1621 and the grid pattern 21 formed on the cover film 19 at the time of thermal bonding (step S5). Next, the individual identification information generating unit 1623 generates individual identification information used for identification of the individual of the matching target PTP sheet 1 from the feature value extracted by the feature value extracting unit 1622 (step S6). Next, the determining unit 1624 compares the individual identification information relating to the individual of the matching target PTP sheet 1 generated by the individual identification information generating unit 1623 with the individual identification information relating to the individual of the registration target PTP sheet 1 stored in the individual identification information DB 152 to determine whether or not the individual of the matching target PTP sheet 1 is identical to any individual of the registration target PTP sheet 1, and outputs the result of the determination (step S7).

Subsequently, the registering unit 161 and the matching unit 162 will be described in detail.

First, the registration image acquiring unit 1611 of the registering unit 161 will be described in detail.

The registration image acquiring unit 1611 may be configured to, for example, acquire an image of the PTP sheet 1 captured after punching into sheet units in the process of manufacturing the PTP sheet 1 by the PTP packaging machine.

In the manufacturing process of the PTP sheet 1, for example, in order to perform a visual inspection such as whether the punching is properly performed, a post-punching inspection apparatus may be provided corresponding to a conveyor that conveys the punched-out PTP sheet 1 in a predetermined posture. Such a post-punching inspection apparatus includes an illuminating unit that irradiates the PTP sheet 1 with predetermined light, an imaging unit that captures an image of the PTP sheet 1 irradiated with the light, and a processing device that performs various processing based on the image captured and obtained by the imaging unit. The registration image acquiring unit 1611 may acquire the image of the PTP sheet 1 captured by the post-punching inspection apparatus as a registration image. Consequently, it is possible to reduce the labor and cost of imaging one individual of the PTP sheet 1 multiple times separately for individual management and for visual inspection. However, it is needless to say that the PTP sheet 1 may be imaged only for individual management.

An image obtained by, while the punched-out PTP sheet 1 is being conveyed by the conveyer with the pocket parts 15 facing up, imaging the PTP sheet 1 on the conveyor by the imaging unit arranged vertically above the conveyor is, as shown in FIG. 1, an image obtained by imaging the PTP sheet 1 from the front face side thereof (projecting side of the pocket part 15). This is an example in which the registration image acquiring unit 1611 acquires a registration image of the PTP sheet 1 captured from the front face side thereof.

Further, an image obtained by, while the punched-out PTP sheet 1 is being conveyed by the conveyor with the pocket parts 15 facing down, imaging the PTP sheet 1 on the conveyor by the imaging unit arranged vertically above the conveyor is, as shown in FIG. 2, an image obtained by imaging the PTP sheet 1 from the back face side thereof (opening side of the pocket parts 15). This is an example in which the registration image acquiring unit 1611 acquires a registration image of the PTP sheet 1 captured from the back face side thereof.

As shown in FIGS. 1 and 2, the PTP sheet 1 targeted in this example embodiment has the print part 20 or 22 and the grid pattern 21 formed on both the front face side and the back face side of the PTP sheet 1. Therefore, the registration image acquiring unit 1611 may be configured to acquire a registration image obtained by imaging the PTP sheet 1 from the front face side and not to acquire an image obtained by imaging the PTP sheet 1 from the back face side. Alternatively, the registration image acquiring unit 1611 may be configured to acquire a registration image obtained by imaging the PTP sheet 1 from the back face side and not to acquire an image obtained by imaging the PTP sheet 1 from the front face side. Alternatively, the registration image acquiring unit 1611 may be configured to acquire both a registration image obtained by imaging the PTP sheet 1 from the front face side and a registration image obtained by imaging the PTP sheet 1 from the back face side. In the following description, for convenience of explanation, it is assumed that the registration image acquiring unit 1611 is configured to acquire only a registration image obtained by imaging the PTP sheet 1 from the front face side.

Next, the feature value extracting unit 1612 of the registering unit 161 will be described in detail.

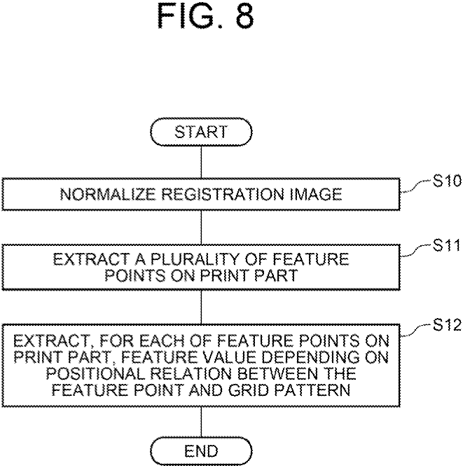

FIG. 8 is a flowchart showing an example of processing by the feature value extracting unit 1612. Referring to FIG. 8, first, the feature value extracting unit 1612 generates a normalized registration image from the registration image (step S10). The normalized registration image is an image in which the orientation and size of the PTP sheet are fixed. Any method may be used to generate the normalized registration image. For example, the feature value extracting unit 1612 may generate the normalized registration image in accordance with the result of matching between a template image having exactly the same print part as the print part 20 (or 22) and the registration image. Hereinafter, the normalized registration image will simply be referred to as a registration image. The feature value extracting unit 1622 of the matching unit 162 also generates a normalized matching image from the matching image by the same method as in the normalization of the registration image.

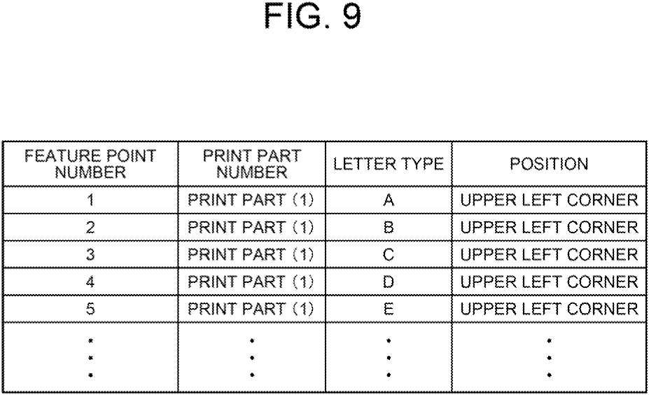

Next, the feature value extracting unit 1612 detects a plurality of feature points on the print part 20 of the registration image (step S11). The plurality of feature points on the print part 20 are defined beforehand. FIG. 9 shows an example of a table in which the plurality of feature points on the print part 20 are defined. The table in this example is composed of a plurality of entries, and each of the entries includes items of feature point number, print part number, letter type, and position. In the item of feature point number, a number which uniquely identifies each of the feature points is set. In the item of print part number, a number which uniquely identifies one print part from among eleven print parts 20 existing on the surface of the PTP sheet 1. For example, in the PTP sheet 1 shown in FIG. 1, a side of the short side part 13 (tag part side) is defined as the upper side, a side of the short side part 14 is defined as the lower side, a side of the long side part 11 is defined as the left side, and a side of the long side part 12 is defined as the right side. In this case, by allocating serial consecutive numbers to the print parts 20 in the raster scan direction from upper left to lower right, it is possible to assign serial numbers to all the print parts 20. In the item of letter type, a letter type that specifies one letter from among a plurality of letters “ABCDE200mg” present in the print part 20 specified by the print part number is set. One letter may be specified by a letter number indicating the number of the letter from the beginning, instead of letter type. In the item of position, a position which specifies a part of one letter specified by the letter type is set. Values set in the item of position include, for example, upper left corner, upper right corner, lower left corner, lower right corner, uppermost edge, lowermost edge, rightmost edge, and leftmost edge. For example, the first row of the table in FIG. 9 defines that a feature point with feature point number 1 is the upper left corner of a letter “A” identified by a letter type A in the print part 20 specified by a print part number 1.

Next, the feature value extracting unit 1612 extracts, for each of the feature points, a feature value that depends on a positional relation between the feature point and the grid pattern near the feature point (step S12).

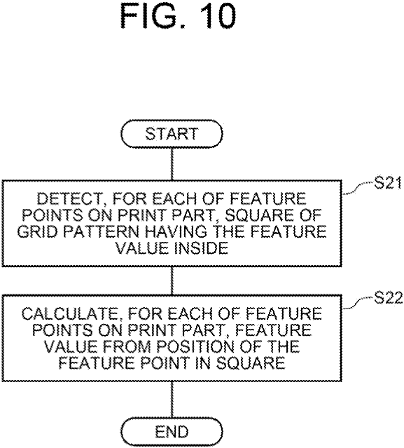

FIG. 10 is a flowchart showing an example of processing at step S12 of FIG. 8. Referring to FIG. 10, the feature value extracting unit 1612 detects, for each feature point, a square of the grid pattern having the feature point inside (step S21). For example, in the case of a feature point 31 defined as the upper left corner of the letter A shown in FIG. 4A, a square of the grid pattern having the feature point 31 inside is a square specified by four vertices 32 to 35. When the feature value extracting unit 1612 does not detect a square having a feature point inside because there is no grid pattern near the feature point, the feature value extracting unit 1612 sets the feature value of the feature point as a specified value, for example.

Next, the feature value extracting unit 1612 extracts, for each of the feature points, position information of the feature point in the detected square as the feature value of the feature point (step S22). Various information is possible as the position information of the feature point in the square.

For example, regarding the position information of the feature point in the square, the feature value extracting unit 1612 may divide the square into a plurality of predetermined partial areas and set information specifying the partial area having the feature point inside as the feature value of the feature point. For example, regarding the feature point 31 shown in FIG. 4, the feature value extracting unit 1612 divides the square having the feature point 31 inside into four partial areas 41 to 44 by line segments connecting the opposing vertices as indicated by dashed lines in FIG. 4A, and sets information specifying the partial area 44 having the feature point 31 inside as the feature value of the feature point 31. The information specifying the partial areas may be, for example, numbers allocated to the four partial areas 41 to 44 (for example, 00, 01, 10, 11 in binary) as shown in FIG. 4A. Although the square is divided into four in the above description, the number of divisions may be any number of two or more. Also, the square may be divided into different sizes, instead of being divided into the same sizes.

Further, regarding the position information of the feature point in the square, the feature value extracting unit 1612 may set a vector from the feature point to a predetermined vertex of the square as the feature value of the feature point. For example, in a case where a vertex on the left side of the four vertices of the square is set as the predetermined vertex, regarding the feature point 31 shown in FIG. 4A, the feature value extracting unit 1612 sets a vector from the feature point 31 to the vertex 35 as the feature value of the feature point 31. Moreover, for example, in a case where a vertex closest to the feature point among the four vertices of the square is set as the predetermined vertex, regarding the feature point 31 shown in FIG. 31, the feature value extracting unit 1612 sets a vector from the feature point 31 to the vertex 32 as the feature value of the feature point 31.

The position information of the feature point in the square described above is an example, and it is needless to say that the position information is not limited to the above information.

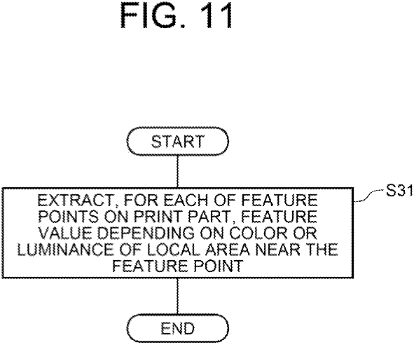

FIG. 11 is a flowchart showing another example of the processing at step S12 of FIG. 8. Referring to FIG. 11, the feature value extracting unit 1612 extracts, for each of the feature points, a feature value depending on the color or luminance of a local area having a predetermined shape and predetermined size near the feature point, as the feature value of the feature point (step S31). In a case where the size of the local area is too large or too small compared with the size of the square, it is difficult to extract a feature value depending on a local displacement between the letter and the grid pattern, so that the size of the local area is preferably about 0.25 to 1.5 times that of the square. Moreover, the shape of the local area is desirably a rectangle for ease of processing, but may be a shape other than a rectangle, such as a circle or triangle. Moreover, regarding the positional relation between the feature point and the local area, in order to avoid an influence of color and luminance of the letter area, it is desirable to set the local area on the opposite side to the letter area where the feature point is set when viewed from the feature point. For example, for the feature point 31 shown in FIG. 4A, a rectangular area drawn by a dashed and dotted line in FIG. 4A with the feature point 31 as one vertex is a local area 51 near the feature point 31. Thus, the feature value extracting unit 1612 extracts a feature value depending on the color or luminance of the local area 51 as the feature value of the feature point 31. Meanwhile, the definition of a local area for every feature point may be set in the table of FIG. 9.

Alternatively, the feature value extracting unit 1612 may set, as the feature value of the feature point, a feature based on statistics on hue or luminance gradient calculated from the color or luminance of the local area, a frequency feature obtained by Fourier transform, or the like, of hue information or luminance information, a binary feature obtained from a magnitude relation of luminance of any pixel pair taken out of the local area.

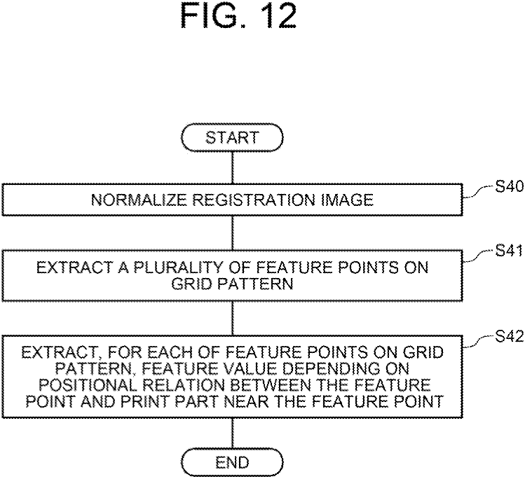

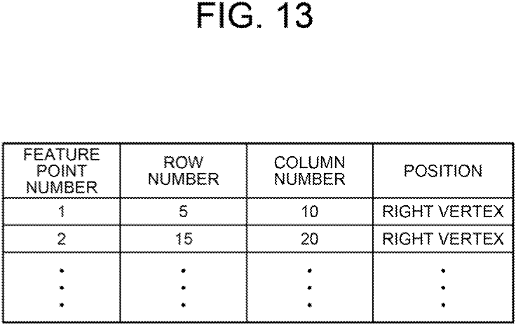

FIG. 12 is a flowchart showing another example of the processing by the feature value extracting unit 1612. Referring to FIG. 12, first, the feature value extracting unit 1612 generates a normalized registration image from the registration image in the same manner as in FIG. 8 (step S40). Next, the feature value extracting unit 1612 detects a plurality of feature points on the grid pattern 21 of the registration image (step S41). The plurality of feature points on the grid pattern 21 are defined beforehand. FIG. 13 shows an example of a table that defines the plurality of feature points on the grid pattern 21. The table in this example is composed of a plurality of entries, and each of the entries includes items of feature point number, row number, column number, and position. In the item of feature point number, a number uniquely identifying each feature point is set. In the items of row number and column number, a row number and a column number that uniquely identify a square having a feature point as a predetermined index are set. For example, in the PTP sheet 1 shown in FIG. 1, the side of the short side part 13 (tag part side) is defined as the upper side, the side of the short side part 14 is defined as the lower side, the side of the longer side part 11 is defined as the left side and the side of the longer side part 12 is defined as the right side, and a sequence from above to bottom is a row direction and a sequence from left to right is a column direction. In this case, by allocating consecutive row numbers and column numbers to the respective rows and columns of the grid pattern 21, it is possible to uniquely identify the respective rows and columns with the row numbers and the column numbers. Since each square of the grid pattern 21 is present at the intersection of the row and the column, it is possible to uniquely identify the square with the row number and the column number. In the item of position, information specifying one vertex of the four vertices of a square is set. For example, the first row in FIG. 13 defines that a feature point with feature point number 1 is a right vertex of a square specified with row number 5 and column number 10 of the grid pattern 21.

Next, the feature value extracting unit 1612 extracts, for each of the feature points, a feature value depending on a positional relation between the feature point and the print part 20 near the feature point, as a feature value of the feature point (step S42).

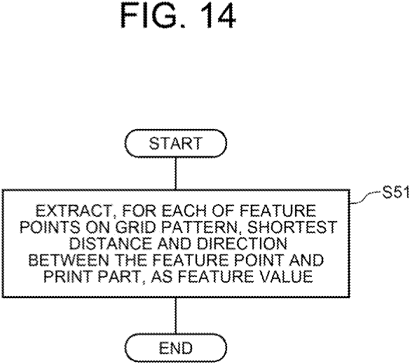

FIG. 14 is a flowchart showing an example of processing at step S42 of FIG. 12. Referring to FIG. 14, the feature value extracting unit 1612 extracts, for each of the feature points, a shortest distance between the feature point and the print part 20 and a direction from the feature point to a shortest distance spot as the feature value of the feature point (step S51). For example, in a case where the vertex 33 in FIG. 4A is one feature point of the grid pattern 21, a shortest distance between the feature point and the print part 20 is given as a normal 52 from the vertex 33 to the letter A. Moreover, a direction from the feature point to the shortest distance spot is given as a direction from an end point of the normal 52 on the side of the vertex 33 to an end point of the normal 52 on the side of the letter A.

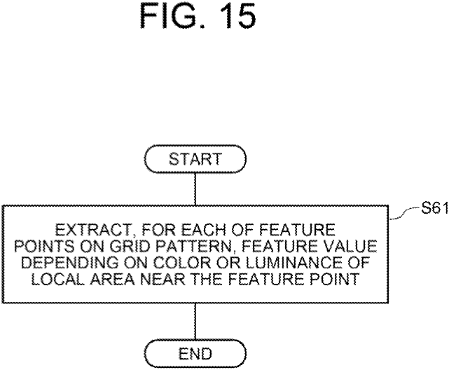

FIG. 15 is a flowchart showing another example of the processing at step S42 of FIG. 12. Referring to FIG. 15, the feature value extracting unit 1612 extracts, for each of the feature points, a feature value that depends on the color or luminance of a local area having a predetermined shape and a predetermined size near the feature value, as the feature value of the feature point (step S61). A method of determining the size and shape of the local area may be the same as the method described for step S31, or may be different. For example, for the feature point 33 shown in FIG. 4A, a rectangular area drawn by a dashed-dotted line in FIG. 4A with the center of gravity at the feature point 33 is set as a local area 53 near the feature point 33. Thus, the feature value extracting unit 1612 extracts a feature value depending on the color or luminance of the local area 53 as the feature value of the feature point 33.

Next, the individual identification information generating unit 1613 of the registering unit 161 will be described in detail.

The individual identification information generating unit 1613 generates individual identification information of the registration image of the PTP sheet 1 by combining the feature values extracted for the respective feature points by the feature value extracting unit 1612. For example, the individual identification information generating unit 1613 may generate individual identification information by connecting the feature values of the feature points in numerical order of the feature point numbers. Assuming that the total number of feature points is n and the number of bits of the feature value of one feature point is m, the size of the individual identification information of the registration image of the PTP sheet 1 is m×n bits. Next, the individual identification information generating unit 1613 stores the individual identification information of the registration image of the PTP sheet 1 into the individual identification information DB 152.

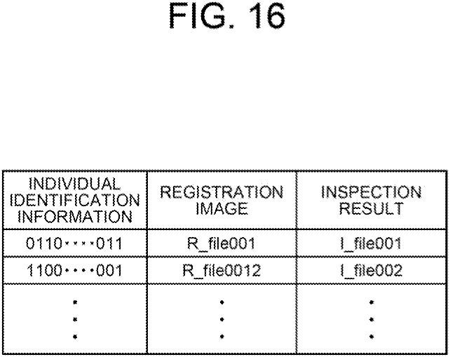

FIG. 16 shows a configuration example of the individual identification information DB 152. The individual identification information DB 152 in this example is composed of a plurality of entries corresponding to the registration images of the PTP sheet 1 on a one-to-one basis, and each of the entries includes items of individual identification information, registration image, and inspection result. In the item of individual identification information, individual identification information generated from the registration image is set. In the item of registration image, the name of a file in which the registration image is recorded is set. In the item of inspection result, the name of a file in which the inspection result of visual inspection of the PTP sheet 1 is recorded is set.

Next, the matching unit 162 will be described in detail. The feature value extracting unit 1622 and the individual identification information generating unit 1623 of the matching unit 162 are different from the feature value extracting unit 1612 and the individual identification information generating unit 1623 of the registering unit 161, only in a target image, that is, whether a matching image or a registration image, and the basic functions thereof are the same. Thus, the matching image acquiring unit 1621 and the determining unit 1624 will be described in detail below.

First, the matching image acquiring unit 1621 of the matching unit 162 will be described in detail.

The matching image acquiring unit 1621 may be configured to acquire an image (matching image) captured by the camera 110 of the PTP sheet 1 for which authenticity determination or provenance confirmation is required, for example. The matching image acquiring unit 1621 acquires an image of the PTP sheet 1 on the same side as the registration image acquired by the registration image acquiring unit 1611 of the registering unit 161. That is to say, in a case where the registration image acquiring unit 1611 is configured to acquire a registration image of the PTP sheet 1 captured from the front face side thereof and not to acquire an image captured from the back face side thereof, the matching image acquiring unit 1621 may acquire only a matching image of the matching target PTP sheet 1 captured from the front face side. Moreover, in a case where the registration image acquiring unit 1611 is configured to acquire a registration image of the PTP sheet 1 captured from the back face side thereof and not to acquire an image captured from the front face side thereof, the matching image acquiring unit 1621 may acquire only a matching image of the target PTP sheet 1 captured from the back face side thereof. Moreover, in a case where the registration image acquiring unit 1611 acquires registration images of the PTP sheet 1 captured from both the front face side and the back face side thereof, the matching image acquiring unit 1621 acquires matching images of the matching target PTP sheet 1 captured from both the front face side and the back face side thereof.

Next, the determining unit 1624 of the matching unit 162 will be described in detail.

First, the determining unit 1624 calculates, for each of the individual identification information of the registration images stored in the individual identification information DB 152, similarity between the individual identification information of the registration image and the individual identification information of the matching image. For example, in a case where the individual identification information is represented by m×n bits as described above, the determining unit 1624 may calculate a Hamming distance between the m×n bits representing the individual identification information of the registration image and the m×n bits representing the individual identification information of the matching image, as the similarity. In a case where the Hamming distance is the similarity, the closer the value of the similarity is to 0, the higher a degree of similarity between the individual identification information of the registration image and the individual identification information of the matching image is. However, the similarity is not limited to the Hamming distance, and the cosine distance (cosine similarity) or the Euclidean distance between two vectors composing the individual identification information of the registration image and the individual identification information of the matching image may be calculated as the similarity of the two individual identification information.

Next, the determining unit 1624 determines whether or not the best similarity among a plurality of similarities calculated above is greater than a threshold value. In a case where the Hamming distance described above is calculated as the similarity, the determining unit 1624 determines whether or not the Hamming distance indicating the best similarity is smaller than the threshold value. When the best similarity is greater than the threshold value, the determining unit 1624 determines that the PTP sheet 1 relating to the matching image is identical to the PTP sheet 1 relating to the registration image having the individual identification information for which the best similarity is calculated. On the other hand, when the best similarity is smaller than the threshold value, the determining unit 1624 determines that the PTP sheet 1 identical to the PTP sheet 1 relating to the matching image is not registered. Next, the determining unit 1624 outputs the determination result. At the time, the determining unit 1624 may retrieve the inspection result of the PTP sheet 1 determined to be identical to the PTP sheet 1 relating to the matching image from the individual identification information DB 152, and output the inspection result together with the determination result.

As described above, according to this example embodiment, individual identification of PTP sheets can be performed without the need for a high-resolution imaging unit. This is because individual identification information used for identification of the PTP sheet 1 is generated from a feature value that depends on a local positional relation between the print part 20 or 22 in an image of the PTP sheet 1 and the grid pattern 21 formed on the cover film 19 at the time of thermal bonding. For example, since the width of one square of the grid pattern 21 is about 0.5 mm to 1.5 mm, an imaging unit with a resolution of about 150 dpi enables observation of a local positional relation between the square and a letter with sufficiently high accuracy. On the other hand, since artifact metrics such as bleed in printing and so-called fingerprints of objects have sizes on the order of micrometers, it is difficult to extract a feature value for individual identification at a resolution of about 150 dpi.

Further, the limit of the resolution of an image of the PTP sheet 1 by an imaging unit of a visual inspection apparatus incorporated in the manufacturing line of the PTP packaging machine that manufactures a large amount of PTP sheets at high speed is about 150 dpi. Therefore, according to this example embodiment, individual identification information can be generated using an inspection image as it is.

Subsequently, a modified example of this example embodiment will be described.

In the above description, the feature value extracting unit 1612 (and the feature value extracting unit 1622) generates individual identification information of the PTP sheet 1 only from a feature value that depends on a local positional relation between a print part and a grid pattern of the PTP sheet 1. However, the feature value extracting unit 1612 (and the feature value extracting unit 1622) may generate individual identification information of the PTP sheet 1 by using, other than the feature value depending on the local positional relation between the print part and the grid pattern of the PTP sheet 1, a feature value that depends on a positional relation between a peripheral part (long side part 11, 12, short side part 13, 14) and the print part 20 (or 22) of the PTP sheet 1, or a feature value that depends on a positional relation between the peripheral part and the grid pattern 21 of the PTP sheet 1. This is because the positional relation between the peripheral part and the print part 20 or the grid pattern 21 of the PTP sheet 1 is rarely the same for all PTP sheets 1, and is often different for each individual.

In the above description, the determining unit 1624 treats bits constituting individual identification information equally, and calculates similarity between the individual identification information of a registration image and the individual identification information of a matching image. However, among the bits constituting the individual identification information, there are bits with high reliability and bits with low reliability. For example, at step S22 of FIG. 10, when a square is divided into a plurality of predetermined partial areas and information specifying a partial area having a feature point therein is used as the feature value of the feature point, a feature value extracted for a feature point located at the boundary of the plurality of partial areas is less reliable. This is because a partial area to which the feature point belongs varies due to a slight difference in imaging environments. Therefore, the feature value extracting unit 1612 (or 1622) generates a reliability indicating the degree of reliability of the extracted feature value in association with the feature value and, when combining the feature values of the respective feature points to generate individual identification information, the individual identification information generating unit 1613 (or 1623) also generates, for each of the bits constituting, a reliability bit corresponding to the reliability associated with the generation source feature value. Then, the determining unit 1624 may calculate similarity between the individual identification information of the registration image and the individual identification information of the matching image, taking into account the reliability bits. For example, the determining unit 1624 may multiply the similarity between bits with high reliability by a large weight, multiply the similarity between bits with low reliability by a small weight, and calculate the final similarity by the weighted sum.

In the above description, the registration image acquiring unit 1611 acquires an image obtained by imaging the PTP sheet 1 after punched into sheet units in the manufacturing process of the PTP sheet 1 by the PTP packaging machine. However, in the manufacturing process of the PTP sheet 1 by the PTP packaging machine, the registration image acquiring unit 1611 may acquire, as a registration image of the PTP sheet 1, an image of an intended sheet site to eventually become the PTP sheet 1 before being punched out.

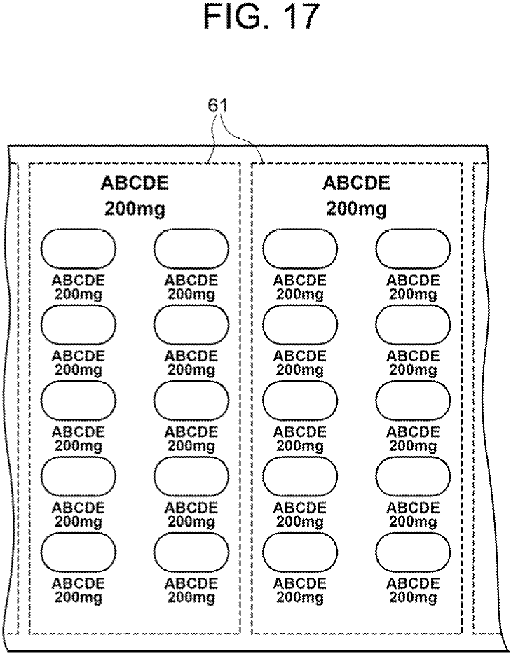

FIG. 17 is a schematic view of a PTP film before punching out PTP sheets, viewed from the projecting side of the pocket parts. In FIG. 17, the grid pattern 21, which originally exists, is not illustrated. In FIG. 17, an area surrounded by a dashed dotted line is an intended sheet area 61 to eventually become one PTP sheet 1.

In the manufacturing process of the PTP sheet 1, for example, in order to inspect for cracked tablets, missing tablets, foreign matter on the tablets, foreign matter on the sheet, and the like, an apparatus may be provided that performs the inspection by imaging the PTP film being conveyed before being punched into the PTP sheet from the projecting side of the pocket parts. Such an inspection apparatus includes an illuminating unit that irradiates the PTP film with predetermined light, an imaging unit that captures an image of the intended sheet area 61 of the PTP film irradiated with the light, and a processing device that performs various processing based on the captured image obtained by the imaging unit. The registration image acquiring unit 1611 may acquire an image of the intended sheet area 61 captured by such an inspection apparatus as a registration image. Consequently, it is possible to reduce the labor and cost of imaging the same individual of the PTP sheet 1 multiple times separately for individual management and visual inspection.

The horizontal slit 18 is formed by a slit forming device on the PTP film being conveyed before being punched into PTP sheets. Thus, when the inspection apparatus is arranged on the upstream side of the slit forming device, the horizontal slit 18 is not yet formed in the intended sheet area 61. Therefore, when extracting a feature value from the intended sheet area 61 in which the horizontal slit 18 is not formed, the feature value extracting unit 1612 desirably avoids an area where the horizontal slit 18 is planned to be formed and extracts a feature value that depends on a local positional relation between the print part 20 and the grid pattern 21. Moreover, there is no guarantee that the intended sheet area 61 is punched out accurately in units of tenths of a millimeter. If a punching error occurs, the positions of the feature points of the grid pattern shown in FIG. 13 are displaced before and after punching, and therefore, the positional relation between the feature point defined on the grid pattern and the print part 20 therearound also shifts before and after punching as described in FIG. 12. In contrast, the position of a feature point defined on the print part 20 described in FIG. 8 is not affected by punching. Therefore, when acquiring a PTP sheet area before being punched as a registration image, it is desirable to extract a feature value that depends on a positional relation between the feature point defined on the print part 20 and the grid pattern therearound.

In the above description, one PTP management apparatus 100 includes the registering unit 161 and the matching unit 162. However, a PTP management apparatus that includes the registering unit 161 and does not include the matching unit 162, or a PTP management apparatus that includes the matching unit 162 and does not include the registering unit 161 is possible.

### Second Example Embodiment

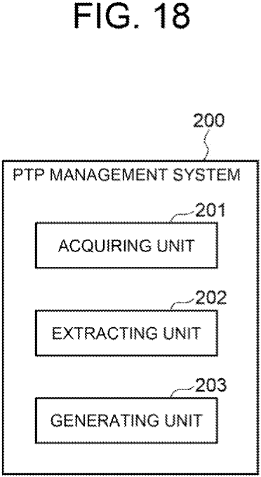

Next, a second example embodiment of the present invention will be described with reference to FIG. 18. FIG. 18 is a block diagram of a PTP management system 200 in this example embodiment. The PTP management system 200 is a system which manages an individual of a PTP sheet formed by housing contents into a plurality of pocket parts having openings on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts.

Referring to FIG. 18, the PTP management system 200 includes an acquiring unit 201, an extracting unit 202, and a generating unit 203.

The acquiring unit 201 is configured to acquire an image of a PTP sheet captured from the opening side or projecting side of the pocket part where the print part is formed. The acquiring unit 201 can be configured, for example, in the same manner as the registration image acquiring unit 1611 of FIG. 5, but is not limited thereto.

The extracting unit 202 is configured to extract a feature value that depends on a local positional relation between the print part in the image acquired by the acquiring unit 201 and a grid pattern formed on the cover film at the time of thermal bonding. The extracting unit 202 can be configured, for example, in the same manner as the feature value extracting unit 1612, but is not limited thereto.

The generating unit 203 is configured to generate individual identification information used for identification of the PTP sheet from the feature value extracted by the extracting unit 202. The generating unit 203 can be configured, for example, in the same manner as the individual identification information generating unit 1613 of FIG. 5, but is not limited thereto.

The PTP management system 200 configured as described above operates in the following manner. First, the acquiring unit 201 acquires an image of a PTP sheet captured from the opening side or projecting side of the pocket part where the print part is formed. Next, the extracting unit 202 extracts a feature value that depends on a local positional relation between the print part in the image acquired by the acquiring unit 201 and a grid pattern formed on the cover film at the time of thermal bonding. Next, the generating unit 203 generates individual identification information used for identification of the PTP sheet from the feature value extracted by the extracting unit 202.

With the configuration and operation as described above, the PTP management system according to this example embodiment can perform individual identification of a PTP sheet without the need for a high-resolution imaging unit. The reason is that identification information used for identification of a PTP sheet is generated from a feature value that depends on a local positional relation between a print part in an image of a PTP sheet and a grid pattern formed on a cover film.

Although the present invention has been described above with reference to the example embodiments, the present invention is not limited to the example embodiments. The configuration and details of the present invention can be changed in various manners that can be understood by one skilled in the art within the scope of the present invention.

The present invention can be utilized for generating individual identification information uniquely identifying a PTP sheet for authentication determination and individual identification of a PTP sheet.

The whole or part of the example embodiments disclosed above can be described as, but not limited to, the following supplementary notes.

### Supplementary Note 1

A PTP management system that manages an individual of a PTP sheet formed by housing contents into a plurality of pocket parts having openings provided on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts, the PTP management system comprising:
an acquiring unit configured to acquire an image of the PTP sheet captured from an opening side or a projecting side of the pocket part on which the print part is formed;
an extracting unit configured to extract a feature value depending on a local positional relation between the print part in the image and a grid pattern formed on the cover film during thermal bonding; and
a generating unit configured to generate individual identification information used for identification of the PTP sheet from the extracted feature value.

### Supplementary Note 2

The PTP management system according to Supplementary Note 1, wherein

the extracting unit is configured to detect a plurality of feature points from the print part and extract, for each of the feature points, a feature value depending on a positional relation between the feature point and the grid pattern near the feature point.

### Supplementary Note 3

The PTP management system according to Supplementary Note 2, wherein

the extracting unit is configured to detect, for each of the feature points, a square of the grid pattern having the feature point therein and extract positional information about the feature point in the square as the feature value.

### Supplementary Note 4

The PTP management system according to Supplementary Note 3, wherein

the extracting unit is configured to divide the square into a plurality of predetermined partial areas and extract information specifying the partial area having the feature point therein as the feature value.

### Supplementary Note 5

The PTP management system according to Supplementary Note 2, wherein

the extracting unit is configured to detect, for each of the feature points, a square of the grid pattern having the feature point therein and extract a vector from the feature point to a predetermined vertex of the square as the feature value.

### Supplementary Note 6

The PTP management system according to Supplementary Note 1, wherein

the extracting unit is configured to detect a plurality of feature points from the print part and extract, for each of the feature points, a feature value depending on color or luminance of a local area near the feature point.

### Supplementary Note 7

The PTP management system according to Supplementary Note 2, wherein

the extracting unit is configured to detect a plurality of feature points from the grid pattern and extract, for each of the feature points, a feature value depending on a positional relation between the feature point and the print part near the feature point.

### Supplementary Note 8

The PTP management system according to Supplementary Note 7, wherein

the extracting unit is configured to extract, for each of the feature points, a vector from the feature point to the print part closest to the feature point as the feature value.

### Supplementary Note 9

The PTP management system according to Supplementary Note 2, wherein

the extracting unit is configured to detect a plurality of feature points from the grid pattern and extract, for each of the feature points, a feature value depending on color or luminance of a local area near the feature point.

### Supplementary Note 10

The PTP management system according to any of Supplementary Notes 1 to 9, wherein

the acquiring unit is configured to acquire the image from an imaging unit included by a PTP packaging machine that manufactures the PTP sheet by filling contents into a band-shaped package film with the pocket parts formed and thereafter thermally boding a cover film with a predetermined print pattern formed to the package film so as to close the pocket parts to form a PTP film and punching out the PTP film into sheet units, the imaging unit being configured to image the PTP sheet after being punched out.

### Supplementary Note 11

The PTP management system according to any of Supplementary Notes 1 to 9, wherein

the acquiring unit is configured to acquire the image from a camera included by a PTP packaging machine that manufactures the PTP sheet by filling contents into a band-shaped package film with the pocket parts formed and thereafter thermally boding a cover film with a predetermined print pattern formed to the package film so as to close the pocket parts to form a PTP film and punching out the PTP film into sheet units, the camera being configured to image an intended sheet site to eventually become the PTP sheet before being punched out.

### Supplementary Note 12

A PTP management method for managing an individual of a PTP sheet formed by housing contents into a plurality of pocket parts having openings provided on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts, the PTP management method comprising:
acquiring an image of the PTP sheet captured from an opening side or a projecting side of the pocket part on which the print part is formed;
extracting a feature value depending on a local positional relation between the print part in the image and a grid pattern formed on the cover film during thermal bonding; and
generating individual identification information used for identification of the PTP sheet from the extracted feature value.

### Supplementary Note 13

The PTP management method according to Supplementary Note 12, comprising

in the extracting, detecting a plurality of feature points from the print part and extracting, for each of the feature points, a feature value depending on a positional relation between the feature point and the grid pattern near the feature point.

### Supplementary Note 14

The PTP management method according to Supplementary Note 13, comprising

in the extracting, detecting, for each of the feature points, a square of the grid pattern having the feature point therein and extracting positional information about the feature point in the square as the feature value.

### Supplementary Note 15

The PTP management method according to Supplementary Note 14, comprising

in the extracting, dividing the square into a plurality of predetermined partial areas and extracting information specifying the partial area having the feature point therein as the feature value.

### Supplementary Note 16

The PTP management method according to Supplementary Note 13, comprising

in the extracting, detecting, for each of the feature points, a square of the grid pattern having the feature point therein and extracting a vector from the feature point to a predetermined vertex of the square as the feature value.

### Supplementary Note 17

The PTP management method according to Supplementary Note 12, comprising

in the extracting, detecting a plurality of feature points from the print part and extracting, for each of the feature points, a feature value depending on color or luminance of a local area near the feature point.

### Supplementary Note 18

The PTP management method according to Supplementary Note 13, comprising

in the extracting, detecting a plurality of feature points from the grid pattern and extracting, for each of the feature points, a feature value depending on a positional relation between the feature point and the print part near the feature point.

### Supplementary Note 19

The PTP management method according to Supplementary Note 18, comprising

in the extracting, extracting, for each of the feature points, a vector from the feature point to the print part closest to the feature point as the feature value.

### Supplementary Note 20

The PTP management method according to Supplementary Note 13, comprising

in the extracting, detecting a plurality of feature points from the grid pattern and extracting, for each of the feature points, a feature value depending on color or luminance of a local area near the feature point.

### Supplementary Note 21

The PTP management method according to any of Supplementary Notes 12 to 20, comprising

in the acquiring, acquiring the image from an imaging unit included by a PTP packaging machine that manufactures the PTP sheet by filling contents into a band-shaped package film with the pocket parts formed and thereafter thermally boding a cover film with a predetermined print pattern formed to the package film so as to close the pocket parts to form a PTP film and punching out the PTP film into sheet units, the imaging unit being configured to image the PTP sheet after being punched out.

### Supplementary Note 22

The PTP management method according to any of Supplementary Notes 12 to 20, comprising

in the acquiring, acquiring the image from a camera included by a PTP packaging machine that manufactures the PTP sheet by filling contents into a band-shaped package film with the pocket parts formed and thereafter thermally boding a cover film with a predetermined print pattern formed to the package film so as to close the pocket parts to form a PTP film and punching out the PTP film into sheet units, the camera being configured to image an intended sheet site to eventually become the PTP sheet before being punched out.

### Supplementary Note 23

A non-transitory computer-readable recording medium on which a computer program comprising instructions for causing a computer to execute processes is recorded thereon, the computer managing an individual of a PTP sheet formed by housing contents into a plurality of pocket parts having openings provided on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts, the processes including:
acquiring an image of the PTP sheet captured from an opening side or a projecting side of the pocket part on which the print part is formed;
extracting a feature value depending on a local positional relation between the print part in the image and a grid pattern formed on the cover film during thermal bonding; and
generating individual identification information used for identification of the PTP sheet from the extracted feature value.

### DESCRIPTION OF NUMERALS

| | |
|---|---|
| 1 | PTP sheet |
| 11–12 | long side part |
| 13–14 | short side part |
| 15 | pocket part |
| 16 | tablet |
| 17 | package film |
| 18 | horizontal slit |
| 19 | cover film |
| 20 | print part |
| 21 | grid pattern |
| 22 | feature point |
| 31 | vertex |
| 32–35 | partial area |
| 41–44 | local area |
| 51, 53 | normal |
| 52 | intended sheet area |
| 61 | PTP management apparatus |
| 100 | camera |
| 110 | communication I/F unit |
| 120 | operation input unit |
| 130 | screen display unit |
| 140 | storing unit |
| 151 | program |
| 152 | individual identification information DB |
| 160 | operation processing unit |
| 161 | registering unit |
| 1611 | registration image acquiring unit |
| 1612 | feature value extracting unit |
| 1613 | individual identification information generating unit |
| 162 | matching unit |
| 1621 | matching image acquiring unit |
| 1622 | feature value extracting unit |
| 1623 | individual identification information generating unit |
| 1624 | determining unit |

What is claimed is:

1. A PTP management apparatus that manages an individual of a PTP sheet formed by housing contents into a plurality of pocket parts having openings provided on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts, the PTP management apparatus comprising:
a memory containing program instructions; and
a processor coupled to the memory, wherein the processor is configured to execute the program instructions to:
acquire an image of the PTP sheet captured from an opening side or a projecting side of the pocket part on which the print part is formed;
extract a feature value depending on a local positional relation between the print part in the image and a grid pattern formed on the cover film during thermal bonding; and
generate individual identification information used for identification of the PTP sheet from the extracted feature value.

2. The PTP management apparatus according to claim 1, wherein the processor is further configured to execute the instructions to:
in the extracting, detect a plurality of feature points from the print part and extract, for each of the feature points, a feature value depending on a positional relation between the feature point and the grid pattern near the feature point.

3. The PTP management apparatus according to claim 2, wherein the processor is further configured to execute the instructions to:
in the extracting, detect, for each of the feature points, a square of the grid pattern having the feature point therein and extract positional information about the feature point in the square as the feature value.

4. The PTP management apparatus according to claim 3, wherein the processor is further configured to execute the instructions to:
in the extracting, divide the square into a plurality of predetermined partial areas and extract information specifying the partial area having the feature point therein as the feature value.

5. The PTP management apparatus according to claim 2, wherein the processor is further configured to execute the instructions to:
in the extracting, detect, for each of the feature points, a square of the grid pattern having the feature point therein and extract a vector from the feature point to a predetermined vertex of the square as the feature value.

6. The PTP management apparatus according to claim 1, wherein the processor is further configured to execute the instructions to:
in the extracting, detect a plurality of feature points from the print part and extract, for each of the feature points, a feature value depending on color or luminance of a local area near the feature point.

7. The PTP management apparatus according to claim 2, wherein the processor is further configured to execute the instructions to:
in the extracting, detect a plurality of feature points from the grid pattern and extract, for each of the feature points, a feature value depending on a positional relation between the feature point and the print part near the feature point.

8. The PTP management apparatus according to claim 7, wherein the processor is further configured to execute the instructions to:
in the extracting, extract, for each of the feature points, a vector from the feature point to the print part closest to the feature point as the feature value.

9. The PTP management apparatus according to claim 2, wherein the processor is further configured to execute the instructions to:
in the extracting, detect a plurality of feature points from the grid pattern and extract, for each of the feature points, a feature value depending on color or luminance of a local area near the feature point.

10. The PTP management apparatus according to any of claim 1, wherein the processor is further configured to execute the instructions to:
in the acquiring, acquire the image from an imaging unit included by a PTP packaging machine that manufactures the PTP sheet by filling contents into a band-shaped package film with the pocket parts formed and thereafter thermally boding a cover film with a predetermined print pattern formed to the package film so as to close the pocket parts to form a PTP film and punching out the PTP film into sheet units, the imaging unit being configured to image the PTP sheet after being punched out.

11. The PTP management apparatus according to claim 1, wherein the processor is further configured to execute the instructions to:
in the acquiring, acquire the image from a camera included by a PTP packaging machine that manufactures the PTP sheet by filling contents into a band-shaped package film with the pocket parts formed and thereafter thermally boding a cover film with a predetermined print pattern formed to the package film so as to close the pocket parts to form a PTP film and punching out the PTP film into sheet units, the camera being configured to image an intended sheet site to eventually become the PTP sheet before being punched out.

12. A PTP management method for managing an individual of a PTP sheet formed by housing contents into a plurality of pocket parts having openings provided on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts, the PTP management method comprising:
acquiring an image of the PTP sheet captured from an opening side or a projecting side of the pocket part on which the print part is formed;
extracting a feature value depending on a local positional relation between the print part in the image and a grid pattern formed on the cover film during thermal bonding; and
generating individual identification information used for identification of the PTP sheet from the extracted feature value.

13. A non-transitory computer-readable recording medium on which a computer program comprising instructions for causing a computer to execute processes is recorded thereon, the computer managing an individual of a PTP sheet formed by housing contents into a plurality of pocket parts having openings provided on one face of a transparent or translucent package film that has the plurality of pocket parts and a flange part provided around the pocket parts to form the one face, and thermally bonding a breakable cover film with a predetermined print part formed on at least one face thereof to the flange part to seal the pocket parts, the processes including:
acquiring an image of the PTP sheet captured from an opening side or a projecting side of the pocket part on which the print part is formed;
extracting a feature value depending on a local positional relation between the print part in the image and a grid pattern formed on the cover film during thermal bonding; and
generating individual identification information used for identification of the PTP sheet from the extracted feature value.
